(19) United States
(12) Patent Application Publication
(10) Pub. No.: US 2006/0162257 A1
(43) Pub. Date: Jul. 27, 2006

(54) Weather strip for motor vehicle

(75) Inventors: Masahiro Nozaki, Aichi-ken (JP); Masanori Aritake, Aichi-ken (JP); Hidenori Furuzawa, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD, Aichi-ken (JP)

(21) Appl. No.: 11/337,525

(22) Filed: Jan. 24, 2006

(30) Foreign Application Priority Data
Jan. 27, 2005 (JP) 2005-019074
Jan. 27, 2005 (JP) 2005-019079

(51) Int. Cl. E06B 7/16

(52) U.S. Cl. 49/490.1

(57) ABSTRACT

A weather strip for a motor vehicle, which is capable of providing a seal between an opening portion of a vehicle body, and a closing member for closing the opening portion. The weather strip includes a base portion in which a flange provided in the opening portion of the vehicle body or the closing member is adapted to be inserted and a seal portion integrally formed with the base portion for contacting the opening portion or the closing member, and sealing between the opening portion and the closing member. The base portion holds a sealant member which is formed separately from the base portion and is composed of a highly foamed sponge material with a specific gravity of not more than 0.2 with a bottom wall thereof, and a projecting end of the flange is inserted into the sealant member.

### CROSS-REFERENCE TO RELATED APPLICATION

This application is related to and claims priority from Japanese patent applications No. 2005-019074 and 2005-019079, incorporated herein by reference.

### BACKGROUND OF THE INVENTION

1. Field of the Invention

The present invention relates to a weather strip for providing a seal between an opening portion of a vehicle body and a closing member for closing the opening portion, such as a vehicle door, a luggage door, a sliding roof, etc.

2. Description of Related Art

FIG. 1 is a perspective view of a motor vehicle. A door opening portion 10 of a vehicle body is formed around a door opening of the motor vehicle, which is closed by a vehicle door 12. The present invention will be explained with reference to weather strips for sealing the door opening portion 10 and the vehicle door 12. The weather strips of the present invention are applicable to the sealing between other opening portions in the vehicle body and other closing members such as rear doors, luggage doors, sliding roofs, etc.

FIG. 2 is a cross-sectional view of a conventional sealing structure between a door opening portion 10 and a vehicle door 12. As shown, a door weather strip 14 is attached to a retainer 16 provided along an outer periphery of a door frame, a glass run 18 is attached to a channel 20 provided along an inner periphery of the door frame, and a door opening trim weather strip 22 is attached to a flange 24 projecting from the door opening portion 10. The flange 24 is formed by joining end edges of an outer body panel 26 and an inner body panel 28 of the vehicle body with the welding method, etc.

The glass run 18 includes an outer side wall 30, a bottom wall 32 and an inner side wall 34, and has a generally U-shaped cross-section. When a door glass 36 is raised, an end of the door glass 36 enters the glass run 18, and is sealed with an outer seal lip 38 and an inner seal lip 40, which respectively project from open ends of the outer side wall 30 and the inner side wall 34.

The door weather strip 14 attached to the outer periphery of the door 12 includes a base portion 42, a tubular seal portion 44 integrally formed on the base portion 42, and a seal lip 46. The base portion 42 is secured to the door frame by fitting the base portion 42 in the retainer 16 provided along the outer periphery of the door frame. When the door 12 is closed, the seal lip 46 contacts an outer end of the door opening portion 10 and the tubular seal portion 44 contacts a protruding part of the door opening portion 10 on the inner side of the contacting position of the seal lip 46 to provide a double seal between the door opening portion 10 and the vehicle door 12.

The door opening trim weather strip 22 attached to the flange 24 provides a seal between the door opening portion 10 and the vehicle door 12 on the inner side of the contacting position of the tubular seal portion 44 of the door weather strip 14. The door opening trim weather strip 22 includes a trim portion 48 having a U-shaped cross-section and a tubular seal portion 50. The trim portion 48 is attached to the flange 24 and the tubular seal portion 50 contacts a protruding part 52 of the door frame to provide a seal between the door opening portion 10 and the vehicle door 12. An insert member 54 such as a metal insert, etc. is embedded in the trim portion 48, and lips are provided in the trim portion 48 for holding the flange 24.

As described above, the flange 24 is formed by joining end edges of the outer body panel 26 and the inner body panel 28 of the vehicle body with the welding method, etc. A space is defined inside the outer body panel 26 and the inner body panel 28 over the entire length of the door opening portion 10 so that noise such as noise reflected from road surfaces is transmitted to the flange 24 by way of the space inside the outer body panel 26 and the inner body panel 28. Where the flange 24 is formed with the spot welding method, concaved parts are formed in surfaces of the flange 24. And, upon sheet metal processing of end edges of the body panels 26 and 28, which are adapted to form the flange 24, concaved parts may be produced along an end edge of the flange 24. As a result, gaps are produced in the flange 24, and the above-described noise leaks from these gaps and is transmitted to a vehicle compartment.

In one example of the prior art, a nondrying sealer having a high viscosity is inserted in an interior of the trim portion 48 of the door opening trim weather strip 22 for preventing the above-described noise, rainwater, dust, etc. from intruding into the vehicle compartment by way of the interior of the trim portion 48 (see Publication of examined Utility model application No. Sho 50-42291, ex.).

This sealer has a high viscosity and is in a liquid state so that the handling thereof is troublesome, and upon reassembling the door opening trim weather strip 22 to the flange 24 after inserting the sealer in the trim portion 48, the sealer may stick to the flange 24 and outer surfaces of the trim portion 48 to make the reassembling of the door opening trim weather strip 22 difficult.

In another example of the prior art, a seal member composed of a sponge rubber, etc. is inserted in the interior of the trim portion 48 for the same purposes as the above-described example (see Publication of unexamined Japanese Utility model application No. Sho 54-165422, ex.). In this case, the work for inserting the seal member of sponge rubber to the bottom of the trim portion 48 and fitting the same thereto is troublesome, and the seal member may move from the inserted position, whereby a projecting end of the flange 24 may not be covered with the seal member sufficiently.

In a further example of the prior art, as shown in FIG. 3, a seal member 56 composed of a sponge material having a specific gravity as low as about 0.1 to 0.5 is extruded into an interior of a trim portion 58 of a door opening trim weather strip 22A integrally therewith to insert a projecting end of the flange 24 in the seal member 56 for enhancing the waterproof properties (see Publications of unexamined Japanese patent application No. Hei 9-315152, ex.). With this arrangement, the seal member 56 is composed of a foamed material, whereas the trim portion 58 is composed of an unfoamed material so that it is difficult to control the integrally extruding process and the following vulcanizing process to lower the production efficiency.

In still another example of the prior art, as shown in FIG. 4, a highly foamed sponge material 60 having a specific gravity of about 0.1 to 0.3 is extruded into an interior of a tubular seal portion 62 integrally therewith for enhancing the sound-insulation properties (see Publication of unexamined Japanese patent application No. 2001-206166, ex.). With this arrangement, it is also difficult to control the integrally extruding process and the following vulcanizing process to lower the production efficiency, similarly to the preceding example.

In still another example of the prior art, as shown in FIG. 5, a double-sided adhesive tape 64 is used to cirtainly secure a door opening trim weather strip 22C to the flange 24 (see Publication of unexamined Japanese patent application No. 2002-127841, ex.). The double-sided adhesive tape 64 is bonded to an interior surface of an inner side wall 68 of a trim portion 70, and the inner side wall 68 is pressed against an exterior surface of the flange 24.

Upon bonding the door opening trim weather strip 22C to the flange 24 with the double-sided adhesive tape 64, after peeling a protecting film, the double-sided adhesive tape 64 is pressed against the flange 24 by putting a root of a cover lip 72, which is connected to the inner side wall 68, to a projecting end of the flange 24, and turning the inner side wall 68 about the root of the cover lip 72 toward the flange 24. However, it is troublesome to position the double-sided adhesive tape 64 on the flange 24, thereby lowering the efficiency of the bonding work of the door opening trim weather strip 22C to a predetermined position of the flange 24.

In still another example of the prior art, as shown in FIG. 6, a double-sided adhesive tape 74 is bonded to an interior surface of an outer side wall 78 of a trim portion 80 of a door opening trim weather strip 22D, and pressed against an exterior surface of the flange 24 (see Publication of unexamined Japanese patent application No. 2000-16193, ex.). With this arrangement, when a projecting end of the flange 24 contacts the double-sided adhesive tape 74 during the insertion of the flange 24 in an interior of the trim portion 80, the double-sided adhesive tape 74 may peel off the trim portion 80, or the flange 24 may not be inserted into the bottom of the trim portion 80.

In still another example of the prior art, as shown in FIG. 7, a nondrying sealer 82 having a high viscosity is inserted in an interior of a trim portion 84 of a door opening trim weather strip 22E for preventing wind noise, rainwater, dust, tire noise, etc. from intruding into the vehicle compartment by way of the interior of the trim portion 84, similarly to the example of FIG. 3 (see Publication of unexamined Japanese Utility model application No. Sho 54-31622, ex.).

This sealer 82 has a high viscosity and is in a liquid state so that the handling thereof is troublesome, and upon reassembling the door opening trim weather strip 22E after inserting the sealer 82 in the trim portion 84, the sealer 82 may stick to the flange 24 and outer surfaces of the trim portion 48 to make the reassembling of the door opening trim weather strip 22E difficult.

### SUMMARY OF THE INVENTION

Accordingly, it is an object of the present invention to provide a weather strip for a motor vehicle, which can be securely attached to a flange extending along an opening portion of a vehicle body or a closing member over the entire length thereof, and can prevent noise, rainwater, etc. from intruding into a vehicle compartment.

In accordance with a first aspect of the present invention, a weather strip for a motor vehicle, which is capable of providing a seal between an opening portion of a vehicle body, and a closing member for closing the opening portion, includes a base portion in which a flange provided in the opening portion of the vehicle body or the closing member is adapted to be inserted, and a seal portion integrally formed with the base portion for contacting the opening portion or the closing member, and sealing between the opening portion and the closing member. The base portion has at least an outer side wall and a bottom wall. A sealant member which is composed of a highly foamed sponge material with a specific gravity of not more than 0.2 and is formed separately from the weather strip is held with the bottom wall, and a projecting end of the flange is inserted into the sealant member.

With this arrangement, the weather strip includes a base portion in which a flange provided in the opening portion or the closing member is adapted to be inserted, and a seal portion integrally formed with the base portion for contacting the opening portion or the closing member, and sealing a gap between the opening portion and the closing member so that when the base portion is attached to the opening portion or the closing member, the seal portion contacts the opening portion or the closing member and provides a seal between the closing member and the opening portion in the closing state of the closing member.

And, since the sealant member which is composed of a highly foamed sponge material with a specific gravity of not more than 0.2 and is formed separately from the weather strip is held with the bottom wall, the sealant member can prevent noise from intruding into a vehicle compartment by way of the flange, and since the sealant member exhibits high flexibility, the force needed to attach the weather strip to the flange can be decreased to facilitate the attachment of the weather strip to the motor vehicle. In addition, the sealant member can be readily formed, and stably placed within the base portion so that the projecting end of the flange can be securely inserted into the sealant member.

In accordance with a second aspect of the present invention, a weather strip for a motor vehicle, which is capable of providing a seal between an opening portion of a vehicle body, and a closing member for closing the opening portion, includes a base portion in which a flange provided in the opening portion of the vehicle body or the closing member is adapted to be inserted, and a seal portion integrally formed with the base portion for contacting the opening portion or the closing member, and sealing between the opening portion and the closing member. The base portion has a generally U-shaped or a generally J-shaped cross-section and includes an outer side wall, an inner side wall and a bottom wall. And a sealant member which is composed of a highly foamed sponge material with a specific gravity of not more than 0.2 and is formed separately from the weather strip is inserted in a bottom of an interior of the base portion, and bonded to the bottom wall.

With this arrangement, the weather strip provides a seal between the closing member and the opening portion in the closing state of the closing member, similarly to the first aspect of the present invention.

Since the base portion has a generally U-shaped or a generally J-shaped cross-section and includes an outer side wall, an inner side wall and a bottom wall, the flange inserted in the base portion is held with the outer side wall, the inner side wall and the bottom wall, and accordingly, the weather strip can be readily attached to the flange, irrespective of variations in the thickness of the flange.

In addition, since the sealant member which is composed of a highly foamed sponge material with a specific gravity of not more than 0.2 and is formed separately from the weather strip is inserted in the bottom of the interior of the base portion, and bonded to the bottom wall, the sealant member can prevent noise from intruding into a vehicle compartment by way of the flange, and since the sealant member exhibits high flexibility, the force needed to attach the weather strip to the flange can be decreased to facilitate the attachment of the weather strip to the motor vehicle. And since the sealant member is formed separately from the base portion, and bonded to the bottom wall, the sealant member can be readily formed, and stably placed within the base portion so that the projecting end of the flange can be securely inserted into the sealant member.

It is preferable that the sealant member is composed of an EPDM rubber or a thermoplastic olefin elastomer, and is fusion welded to an interior of the base portion with an adhesive film composed of a thermoplastic olefin resin. With this arrangement, both the sealant member and the adhesive film are composed of olefin materials so that they can be fusion welded together. And since the adhesive film has a film-like configuraion, the sealant member can be continuously bonded to the base portion through the adhesive film simultaneously with the formation of the base portion. In addition, when the base portion is attached to the flange, the projecting end of the flange is inserted into the sealant member so that a seal is securely provided between the flange and the base portion.

In accordance with a third aspect of the present invention, a weather strip for a motor vehicle, which is capable of providing a seal between an opening portion of a vehicle body, and a closing member for closing the opening portion, includes a base portion in which a flange provided in the opening portion of the vehicle body or the closing member is adapted to be inserted, and a seal portion integrally formed with the base portion for contacting the opening portion or the closing member, and sealing between the opening portion and the closing member. The base portion includes at least an outer side wall and a bottom wall, and has at least a generally L-shaped cross-section. A double-sided adhesive tape is bonded to an interior surface of the outer side wall such that the outer side wall is bonded to an exterior side face of the flange with the double-sided adhesive tape. And a sealant member which is composed of a highly foamed sponge material with a specific gravity of not more than 0.2 and is formed separately from the weather strip is bonded to the bottom wall for inserting a projecting end of the flange thereinto.

With this arrangement, the weather strip provides a seal between the closing member and the opening portion in the closing state of the closing member, similarly to the first and second aspects of the present invention.

Since the base portion has at least a generally L-shaped cross-section and includes at least an outer side wall and a bottom wall, a projecting end of the flange can slide on a tip end of a sealant holding lip which extends from the bottom wall obliquely toward the outer side wall to be inserted in the interior of the base portion. As a result, the projecting end of the flange can be covered with the outer side wall, the bottom wall and the sealant holding lip.

And since a double-sided adhesive tape is bonded to an interior surface of the outer side wall such that the outer side wall is bonded to an exterior side face of the flange with the double-sided adhesive tape, the weather strip can be readily attached to the flange irrespective of variations in the thickness of the flange by pressing the outer side wall against the side face of the flange through the double-sided adhesive tape.

Since a projecting end of the flange is inserted into the sealant member which is composed of a highly foamed sponge material with a specific gravity of not more than 0.2 and is formed separately from the weather strip, the sealant member can prevent noise from intruding into a vehicle compartment by way of the flange, and prevent rainwater, dust, etc. from intruding into a space between the weather strip and the flange. Since the sealant member is composed of a highly foamed sponge material with a specific gravity of not more than 0.2, the projecting end of the flange can be readily inserted into the sealant member so as to decrease the force needed to attach the weather strip to the flange.

In addition, after inserting the projecting end of the flange into the sealant member, the outer side wall is turned to be bonded to the side face of the flange so that both the inserting of the projecting end of the flange and the bonding of the outer side wall to the flange can be carried out securely.

It is preferable that the sealant holding lip has such a height that when the flange is inserted in the interior of the base portion, the flange slides on a tip end of the sealant holding lip and is inserted into the sealant member. With this arrangement, by sliding the projecting end of the flange on the tip end of the sealant holding lip, the flange is guided into the interior of the base portion and is inserted into the sealant member. When the weather strip is attached to the flange, the attaching position relative to the flange can be determined in this manner.

By pressing the outer side wall of the weather strip against the side face of the flange after guiding the projecting end of the flange in the base portion, the projecting end of the flange is inserted into and covered with the sponge-shaped sealant member. Then, by turning the outer side wall of the base portion toward the side face of the flange, the double-sided adhesive tape can be brought into close contact with the flange. And by strongly pressing the double-sided adhesive tape against the side face of the flange, the outer side wall is firmly bonded to the flange.

It is preferable that the base portion further includes a sealant holding projection which projects from an interior surface of the outer side wall along the bottom wall for holding the sealant member with the sealant holding lip and the bottom wall.

With this arrangement, the sealant member can be held by pressing the sealant member with the sealant holding projection and the sealant holding lip, thereby facilitating the mounting of the sealant member. In case of the sealant holding projection being composed of a hard resin, the sealant holding projection serves as a center of bending of the base portion of the weather strip when attached to a corner area of the vehicle, thereby preventing the abnormal deformation of the weather strip.

In a preferred embodiment, the closing member is a vehicle door, and the weather strip is a door opening trim weather strip. In the present embodiment, the weather strip can securely prevent noise from intruding into a vehicle compartment by way of gaps in the flange.

In another preferred embodiment, an insert member is embedded in the base portion so as to be separable in the base portion into a plurality of insert pieces, or to be contractible and stretchable in the base portion. In the present embodiment, the insert member enhances the holding force of the weather strip against the flange, and flexibly bends the base portion to conform to the configuration of the opening portion of the vehicle body or the outer periphery of the closing member, such as a curved configuration thereof.

In a further preferred embodiment, the base portion is composed of a solid material or a slightly foamed material, and the seal portion is composed of a sponge material and is formed to have a tubular configuration. In the present embodiment, the base portion composed of a solid material or a slightly foamed material can securely hold the flange, and the tubular seal portion composed of a sponge material can flexibly contact the opening portion of the vehicle body or the outer periphery of the closing member to enhance the sealing properties.

It is preferable that the seal portion is composed of a sponge material of an EPDM rubber or a thermoplastic olefin elastomer, and the base portion is composed of a solid material or a slightly foamed material of an EPDM rubber or a thermoplastic olefin elastomer. With this arrangement, the seal portion and the base portion can be formed simultaneously by extrusion, using the same kind of materials, whereby weather strips having good weather resistance can be obtained. In addition, since these materials are olefin materials, they can be recycled for reusing without separating them from each other. As a result, weather strips capable of being readily recycled can be obtained.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a perspective view of a vehicle body, which shows an attaching state of a door opening trim weather strip as one example of a weather strip in accordance with the present invention;

FIG. 2 is a cross-sectional view of a conventional sealing structure between a door opening portion of a vehicle body and a vehicle door, which includes one example of a conventional weather strip;

FIG. 3 is a partially cut away cross-sectional view of another example of a conventional weather strip which is attached to the door opening portion;

FIG. 4 is a partially cut away cross-sectional view of another example of a conventional weather strip which is attached to the door opening portion;

FIG. 5 is a partially cut away cross-sectional view of a further example of a conventional weather strip which is attached to the door opening portion;

FIG. 6 is a partially cut away cross-sectional view of still another example of a conventional weather strip which is attached to the door opening portion;

FIG. 7 is a partially cut away cross-sectional view of still another example of a conventional weather strip which is attached to the door opening portion;

FIG. 8 is a front view of one embodiment of a weather strip in accordance with the present invention;

FIG. 9 is a cross-sectional view showing the attaching state of one embodiment of the weather strip in accordance with the present invention, which is taken along the line A-A of FIG. 8;

FIG. 10 is a cross-sectional view showing the attaching state of another embodiment of the weather strip in accordance with the present invention, which is taken along the line A-A of FIG. 8;

FIG. 11 is a cross-sectional view showing the attaching state of a further embodiment of the weather strip in accordance with the present invention, which is taken along the line A-A of FIG. 8; and

FIG. 12 is a cross-sectional view showing the attaching state of still another embodiment of the door opening trim weather strip in accordance with the present invention, which is taken along the line A-A of FIG. 8.

### DETAILED DESCRIPTION OF THE PREFERRED EMBODIMENTS

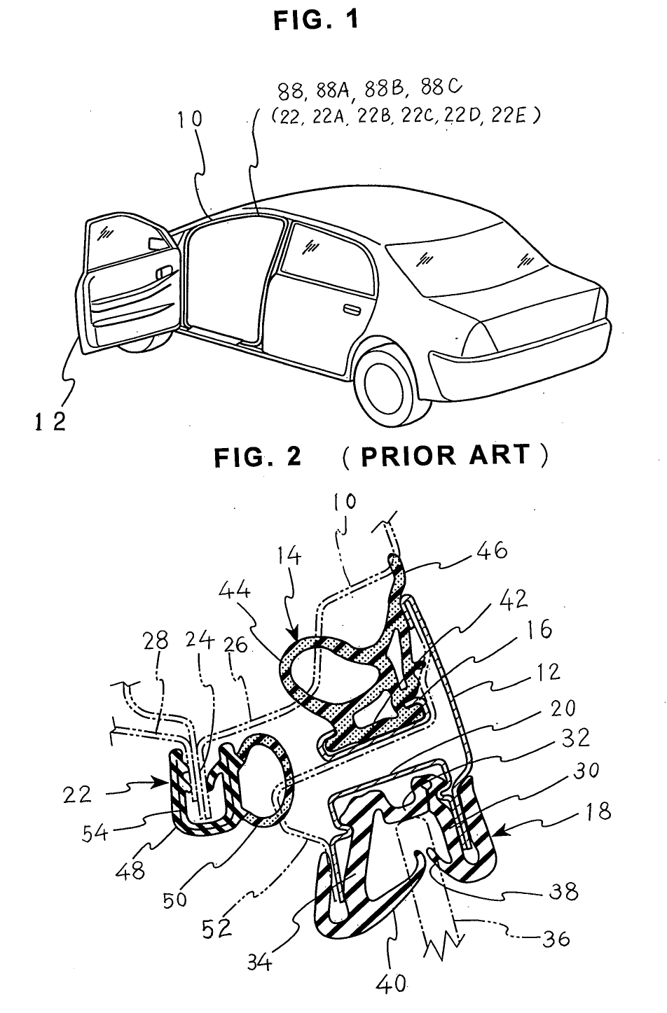

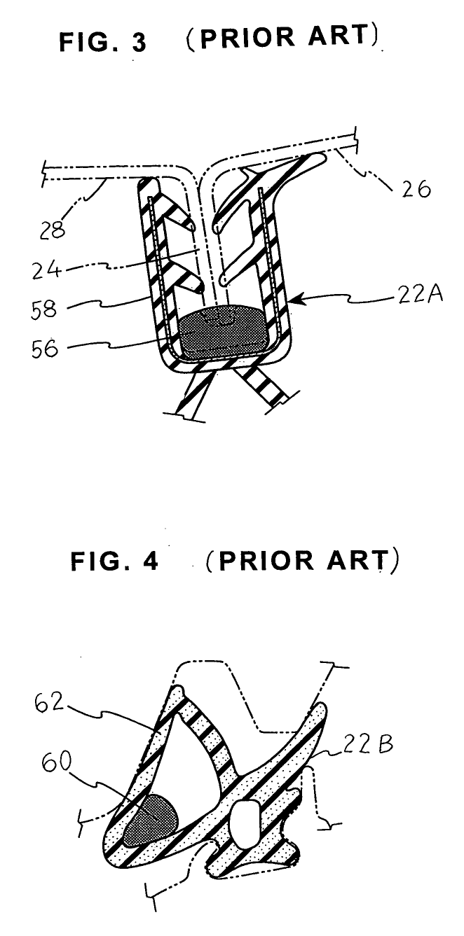

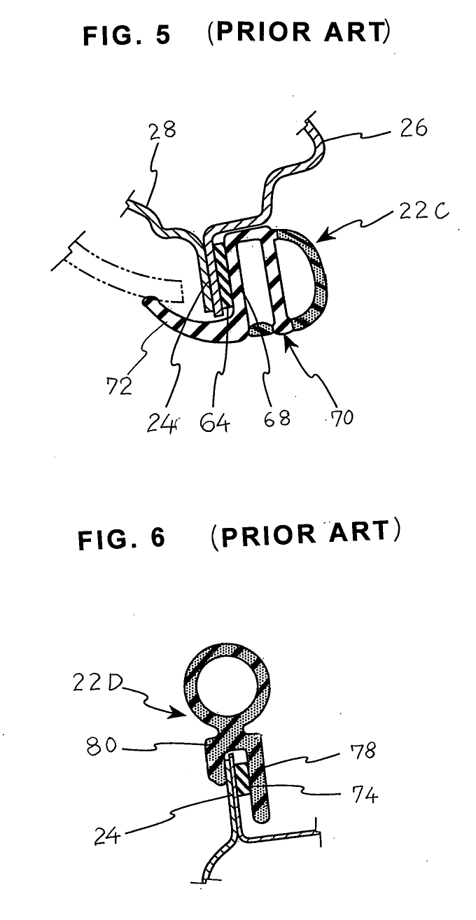

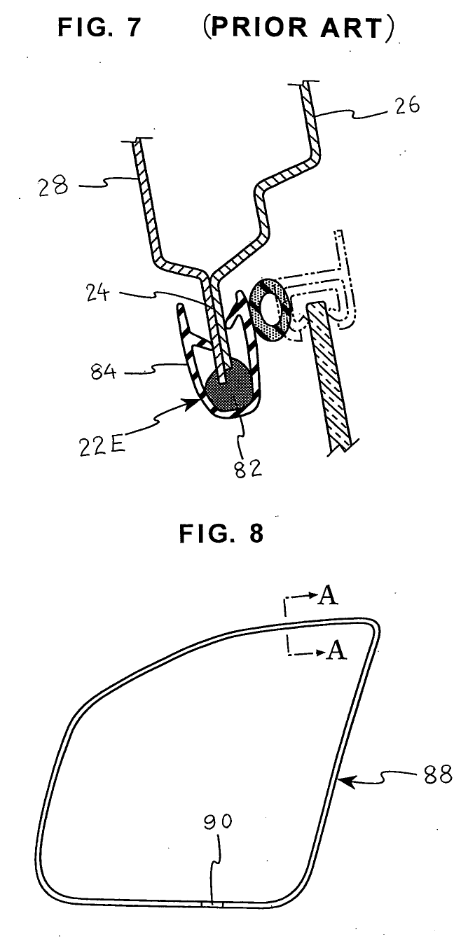

Hereinafter, embodiments of the present invention will be explained with reference to FIGS. 1, 8, 9 through 12. In these embodiments, the present invention is applied to door opening trim weather strips. The present invention is also applicable to other weather strips, each being attached to an opening portion of a vehicle body or a closing member for closing the opening portion, such as door weather strips, luggage weather strips, rear door weather strips etc.

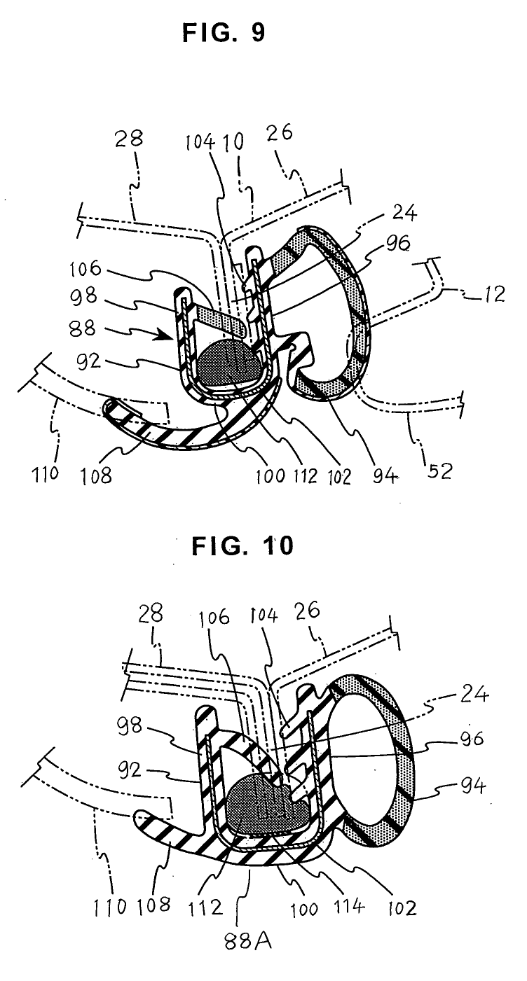

As shown in FIG. 1, a door opening portion 10 of a vehicle body is formed around a door opening of the motor vehicle, which is closed by a vehicle door 12, and a door opening trim weather strip 88 is attached along the door opening portion 10. As shown in FIG. 9, the door opening trim weather strip 88 is attached to a flange 24 formed by welding ends of an outer body panel 26 composing the door opening portion 10 and an inner body panel 28 together.

The door opening trim weather strip 88 is formed by extrusion into a linear configuration, and is attached along the door opening portion 10 into a ring-shaped configuration. After attaching, ends of the door opening trim weather strip 88 are connected to each other. As shown in FIG. 8, ends of the door opening trim weather strip 88 may be connected to each other with a connection 90 which is formed by molding. Alternatively, the ends of the door opening trim weather strip 88 may be bonded to each other into an annular configuration before attaching to the door opening portion 10.

As shown in FIG. 9, the door opening trim weather strip 88 has a base portion (trim portion) 92 for attachment to the flange 24, and a tubular seal portion 94 for contacting a protruding part 52 of a door frame of the door 12 and providing a seal between the door 12 and the door opening portion 10.

The trim portion 92 includes an outer side wall 96, an inner side wall 98 and a bottom wall 100, and has a U-shaped cross-section. To enhance the holding force of the trim portion 92 against the flange 24, an insert member 102 is embedded in the trim portion 92.

The insert member 102 is composed of a metal sheet, metal wire, or a hard synthetic resin. In case of the metal sheet or the hard synthetic resin, a plurality of strip-shaped insert pieces are arranged in parallel with each other in a longitudinal direction of the trim portion 92, and connected to each other into a ladder-shaped configuration or a fish bone-shaped configuration. Alternatively, a plurality of strip-shaped insert pieces are arranged in a longitudinal direction of the trim portion 92, and connected to each other into a zigzag configuration. To enhance the flexibility of the trim portion 92, after embedded, the insert member 102 may be cut at every one or more connections of the strip-shaped insert pieces. The zigzag insert member 102 exhibits elasticity and flexibility in a longitudinal direction thereof. In case of the metal wire, it is used as a wire carrier type member prepared by bending the metal wire to a zigzag configuration and holding it with threads in a longitudinal direction thereof.

A plurality of short outer holding lips 104 are provided in the outer side wall 96, whereas one long inner holding lip 106 is provided in the inner side wall 98. They obliquely extend toward the bottom wall 100 of the trim portion 92. When the flange 24 is inserted in the interior of the trim portion 92, the holding lips 104 and 106 contact surfaces of the flange 24 to attach the door opening trim weather strip 88 to the flange 24. The number of body panels adapted to compose the flange 24 varies according to the position in the door opening portion 10 so that the thickness of the flange 24 locally changes. The inner holding lip 106 bends flexibly with the change of the thickness of the flange 24 to hold the flange 24 securely, irrespective of variations in the thickness of the flange 24.

A cover lip 108 projects from the bottom wall 100 inwardly to cover an outer end of a garnish 110, thereby effecting a good outer appearance therearound.

The tubular seal portion 94 is integrally formed on the outer side wall 96. When the door 12 is closed, the tubular seal portion 94 contacts the protruding part 52 of the door 12 to provide a seal between the door 12 and the door opening portion 10. A lip-like seal portion may be provided instead of the tubular seal portion 94. The tubular seal portion 94 is composed of a sponge material of an EPDM rubber or a thermoplastic olefin elastomer, and the trim portion 92 is composed of a solid material or a slightly foamed material of an EPDM rubber or a thermoplastic olefin elastomer. With this arrangement, resultant opening trim weather strips exhibit good weather resistance. In addition, the resultant opening trim weather strips are entirely composed of olefin materials so that they can be pulverized together and recycled for reusing.

A sealant member 112 is inserted in the interior of the trim portion 92. The sealant member 112 is composed of a highly foamed sponge having a specific gravity of not more than 0.2 and is formed separately from the opening trim weather strip 88 by extrusion. It is preferable to compose the sealant member 112 of an EPDM rubber or a thermoplastic olefin elastomer.

The door opening trim weather strip 88 thus arranged is formed by integrally extruding the insert member 102, a solid rubber for the trim portion 96 and a sponge rubber for the tubular seal portion 96 with an extruder such that side walls are spread apart to enlarge a mouth of the trim portion 96.

A synthetic rubber such as an EPDM rubber, etc. and a thermoplastic elastomer such as a polyolefin elastomer, etc. are used as the forming material of the door opening trim weather strip 88. The sponge material is prepared by foaming the above-described EPDM rubber and the thermoplastic elastomer.

In case of the synthetic rubber, after extruded, it is heated in a vulcanizing chamber with a hot air and high frequency wave for vulcanizing and foaming. In case of the thermoplastic elastomer or the soft synthetic resin, it is heated during extrusion or after extruded for foaming, and cooled for solidifying.

Next, the sealant member 112 is inserted from the enlarged mouth of the trim portion 92 to the bottom thereof, and the insert member 102 embedded in the trim portion 92 is cut into insert pieces. Then, after the trim portion 92 is bent to have a generally U-shaped cross-section to hold the sealant member 112 with the outer side wall 96, the bottom wall 100 and the inner side wall 98, a resultant weather strip 88 is cut to a predetermined length and is attached to the flange 24.

Since the sealant member 112 is composed of the material of which the specific gravity is not more than 0.2 and accordingly, exhibits a high flexibility, a projecting end of the flange 24 can be readily inserted into the sealant member 112, whereby the force needed to insert the flange 24 into the sealant member 112 decreases to facilitate the attachment of the opening trim weather strip 88 to the flange 24.

The sealant member 112 thus arranged prevents noise from leaking by way of gaps which have been formed between adjacent body panels adapted to compose the flange 24 during the spot welding process and bending process of the body panels, and prevents rainwater, dust, etc. from intruding into gaps between the door opening trim weather strip 88 and the flange 24 FIG. 10 illustrates another embodiment of the present invention. As shown, a door opening trim weather strip 88A has the construction substantially equal to that of the door opening trim weather strip 88 of FIG. 9, and accordingly, repetition of the explanation thereof will be omitted, and identical reference numerals have been used in FIG. 10 to denote generally identical components to those in FIG. 9.

As shown in FIG. 10, a tape-shaped adhesive sheet 114 composed of a thermoplastic olefin elastomer or a thermoplastic olefin resin, such as a low density polyethylene, is bonded to an interior surface of a bottom wall 100 of a trim portion 92 of a door opening trim weather strip 88A. A strip-shaped sealant member 112 inserted in the trim portion 92 can be fusion welded using the adhesive sheet 114.

The door opening trim weather strip 88A is formed, similarly to the door opening trim weather strip 88. After extrusion, or after vulcanization of the trim portion 92 of the door opening trim weather strip 88A, the tape-shaped adhesive sheet 114 is continuously inserted into the trim portion 92 from the enlarged mouth thereof, and is placed on the interior surface of the bottom wall 100 of the trim portion 92 which is in a heated state. The adhesive sheet 114 thus placed is melted with heat of the trim portion 92 and is bonded thereto. By pressing the sealant member 112 which has been formed separately against the adhesive sheet 114, the molten adhesive sheet 114 and the sealant member 112 are welded and bonded together.

The sealant member 112 is composed of an EPDM rubber or a thermoplastic olefin elastomer. Therefore, the sealant member 112 and the adhesive sheet 114 are both olefin materials so that they can be readily fusion welded together strongly. And since the adhesive sheet 114 has a film-like configuration, the sealant member 112 can be bonded to the trim portion 92 composed of an EPDM rubber or a thermoplastic olefin elastomer through the adhesive sheet 114 continuously with the formation of the trim portion 92.

The sealant member 112 may be bonded using an adhesive agent instead of the adhesive sheet 114.

Alternatively, the adhesive sheet 114 may be bonded to the sealant member 112 before fusion welding of the sealant member 112 to the trim portion 92.

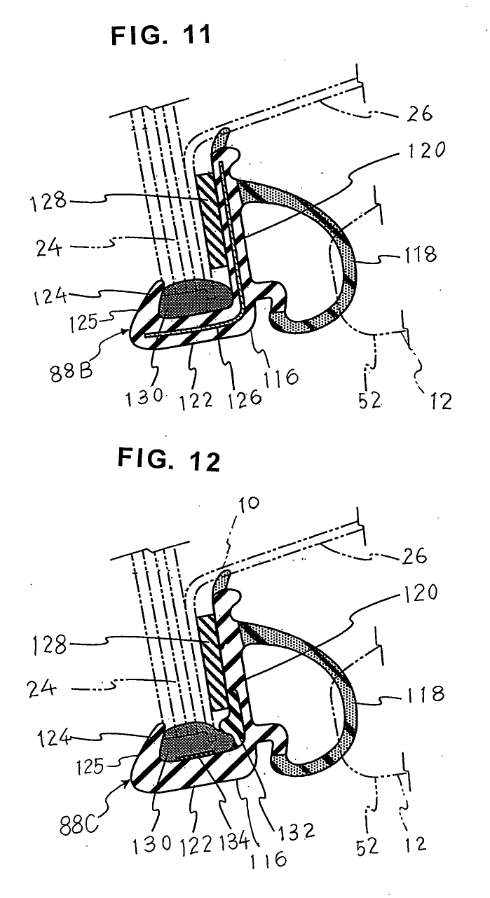

FIGS. 11 illustrates a further embodiment of the present invention. As shown, a door opening trim weather strip 88B has a base portion (trim portion) 116 for attachment to the flange 24, and a tubular seal portion 118 integrally formed with the trim portion 116 for contacting a protruding part 52 of a door frame of a door 12 and providing a seal between the door 12 and the door opening portion 10. The trim portion 116 includes at least an outer side wall 120 and a bottom wall 122, and has at least an L-shaped cross-section. The trim portion 116 may further include a sealant holding lip 124 to have a J-shaped cross-section. A double-sided adhesive tape 128 is bonded to an interior surface of the outer side wall 120. To enhance the holding force of the trim portion 116 against the flange 24, an L-shaped insert member 126 having a similar arrangement to the insert member 102 of FIG. 9 is embedded in the trim portion 116.

The tubular seal portion 118 is integrally formed on the outer side wall 120. The tubular seal portion 118 has a generally elliptical cross-section and is composed of a sponge material such as a sponge rubber, a sponge thermoplastic olefin elastomer, etc. When the door 12 is closed, the tubular seal portion 118 contacts the protruding part 52 of the door 12 to provide a seal between the door 12 and the door opening portion 10. A lip-shaped seal portion may be provided instead of the tubular seal portion 118.

The sealant holding lip 124 projects from an inner side edge of the bottom wall 122 obliquely upwardly to have a lip-like cross-section. The sealant holding lip 124 has such a height as to hold a sealant member 130 inserted in an interior of the trim portion 116 with the outer side wall 120. A sliding layer 125 may be provided on an outer surface of the sealant holding lip 124 by applying a silicon film, a urethane film, etc. which exhibits a low sliding resistance thereto.

The sealant member 130 is formed by extruding an EPDM rubber or a thermoplastic elastomer separately from the opening trim weather strip 88B, and foaming the extruded material at a high expansion ratio to a specific gravity of not more than 0.2.

In case of the synthetic rubber, after extruded, it is heated in a vulcanizing chamber with a hot air and high frequency wave for vulcanizing and foaming. In case of the thermoplastic elastomer or the soft synthetic resin, it is heated during extrusion or after extruded for foaming, and cooled for solidifying.

The door opening trim weather strip 88B thus arranged is formed by integrally extruding the insert member 126, a solid rubber for the trim portion 116 and a sponge rubber for the tubular seal portion 118 with an extruder.

Next, the sealant member 130 is inserted to the bottom of the trim portion 116, and the insert member 126 embedded in the trim portion 116 is cut into insert pieces. Then, after the trim portion 116 is bent to have a generally J-shaped cross-section to hold the sealant member 130 with the outer side wall 120, the bottom wall 122 and the sealant holding lip 124, a resultant weather strip 88B is cut to a predetermined length and is attached to the flange 24.

A synthetic rubber such as an EPDM rubber, etc. and a thermoplastic elastomer such as a polyolefin elastomer, etc. are used as the forming material of the door opening trim weather strip 88B. The sponge material is prepared by foaming the above-described EPDM rubber and the thermoplastic elastomer.

Then, the door opening trim weather strip 88B thus produced is cut to predetermined dimensions. The door opening trim weather strip 88B thus prepared is attached to the flange 24 by bonding the double-sided adhesive tape 128 to an exterior surface of the flange 24.

Upon attaching the opening trim weather strip 88B to the flange 24, the opening trim weather strip 88B is brought close to the flange 24 from the exterior side thereof, and is pressed thereagainst in a transverse direction. As a result, the projecting end of the flange 24 contacts the sliding layer 125 provided on the sealant holding lip 124 and slides thereon. Consequently, the projecting end of the flange 24 is inserted into the sealant member 130 which has been inserted in the trim portion 116. Then, the outer side wall 120 of the trim portion 116 is pressed against an exterior side face of the flange 24 to bring the double-sided adhesive tape 128 into close contact with the flange 24. As a result, the outer side wall 120 is bonded to the exterior side face of the flange 24 strongly through the double-sided adhesive tape 128.

The sealant member 130 is composed of a highly foamed sponge having a specific gravity of not more than 0.2. It is preferable to use an EPDM rubber or a thermoplastic olefin elastomer, because the trim portion 116 is preferably composed of an EPDM rubber or a thermoplastic olefin elastomer, and by composing the sealant member 130 and the trim portion 116 of similar materials, they can be bonded to each other strongly. By composing the sealant member 130 of the material of which the specific gravity is not more than 0.2, the sealant member 130 exhibits a high flexibility so that when the opening trim weather strip 88B is attached to the flange 24, the projecting end of the flange 24 can be readily inserted into the sealant member 130, whereby the force needed to insert the flange 24 in the sealant member 130 decreases to facilitate the attachment of the door opening trim weather strip 88B to the flange 24.

The sealant member 130 is fitted in the interior of the trim portion 116 and is held with the sealant holding lip 124, the bottom wall 122 and the outer sidewall 120.

The sealant member 130 thus arranged prevents noise from leaking by way of gaps which have been formed between adjacent body panels adapted to compose the flange 24 during the spot welding process and bending process of the body panels, and prevents rainwater, dust, etc. from intruding into gaps between the door opening trim weather strip 88B and the flange 24

Alternatively, the sealant member 130 may be secured to the trim portion 116 using an adhesive sheet or an adhesive agent. In this case, the trim portion 116 need not have the above-described sealant holding lip.

FIG. 12 illustrates still another embodiment of the present invention. As shown, a door opening trim weather strip 88C has the construction substantially equal to that of the door opening trim weather strip 88B of FIG. 11, and accordingly, repetition of the explanation thereof will be omitted, and identical reference numerals have been used in FIG. 12 to denote generally identical components to those in FIG. 11.

In the present embodiment, no insert member is embedded in the trim portion 116, and a sealant holding projection 132 is further provided in the outer side wall 120 so as to project inwardly from the position along the bottom wall 122.

The sealant member 130 inserted in the trim portion 116 is held with the bottom wall 122 and the sealant holding lip 124 and the sealant holding projection 132. With this arrangement, the sealant member 130 can be pressed between the sealant holding lip 140 and the sealant holding projection 132, thereby facilitating the insertion of the sealant member 130 in the trim portion 116. The sealant holding projection 132 is integrally formed with the trim portion 116, and may be composed of a hard material, as compared with the material of the outer side wall 120. When the door opening trim weather strip 88C is attached along a corner of the door opening portion 10, the sealant holding projection 132 composed of such a hard material can serve as a center of bending of the trim portion 116, thereby preventing the abnormal deformation of the door opening trim weather strip 88C.

An adhesive sheet 134 composed of a thermoplastic olefin elastomer is bonded to an interior surface of the bottom wall 122 of the trim portion 116. The sealant member 130 inserted in the trim portion 116 can be fusion welded using the adhesive sheet 134.

The door opening trim weather strip 88C thus arranged is formed by integrally extruding a solid rubber for the trim portion 116, a hard material for the sealant holding projection 132 and a sponge rubber for the tubular seal portion 118 with an extruder to have a J-shaped cross-section.

After the extrusion process or after the vulcanization process, the tape-shaped adhesive sheet 134 is continuously inserted in the interior of the trim portion 116. The adhesive sheet 134 is melted with heat of the trim portion 116 and is bonded thereto. Then, the previously prepared strip-shaped sealant member 130 is pressure bonded on the adhesive sheet 134.

The sealant member 130 and the adhesive sheet 134 are both olefin materials so that they can be readily welded together strongly. And since the adhesive sheet 134 has a film-shaped configuration, the adhesive sheet 134 can be continuously bonded to the bottom wall 122 simultaneously with the formation of the trim portion 116.

As a result, the sealant member 130 is bonded to the interior of the trim portion 116.

Since the projecting end of the flange 24 is inserted into the sealant member 130, a secure seal can be provided between the flange 24 and the opening trim weather strip 88C.

Resultant door opening trim weather strip 88C is cut to predetermined dimensions, and attached to the flange 24 provided in the door opening portion 10 of the vehicle body.

Upon attaching the door opening trim weather strip 88C to the flange 24, the door opening trim weather strip 88C is brought close to the flange 24 and is pressed thereagainst in a transverse direction, similarly to the door opening trim weather strip 88B.

Since the sealant member 130 is composed of a highly foamed sponge material of which the specific gravity is not more than 0.2, the sealant member 130 exhibits a high flexibility so that when the opening trim weather strip 88C is attached to the flange 24, a projecting end of the flange 24 can be readily inserted into the sealant member 130, whereby the force needed to insert the flange 24 in the sealant member 130 can be decreased.

The sealant member 130 thus arranged prevents noise from leaking by way of gaps which have been formed between adjacent body panels adapted to compose the flange 24 during the spot welding process and bending process of the body panels, and prevents rainwater, dust, etc. from intruding into gaps between the door opening trim weather strip 88C and the flange 24

Alternatively, the opening trim weather strip 88C may be attached to the flange 24 by inserting the flange 24 in the trim portion 116 or by temporarily fixing the trim portion 116 to the flange 24 with side walls of the trim portion 116 slightly spread apart, and fixing the temporarily fixed trim portion 116 to the flange 24 with the roll forming method.

As described above, with the weather strip of the present invention, a sealant member formed of a highly foamed sponge material with a specific gravity of not more than 0.2 is prepared separately from the weather strip and inserted and held in a base portion so that noise, etc. can be prevented from intruding into a vehicle compartment by way of a flange extending along a opening portion of a vehicle body or a closing member, and rainwater, dust, etc. can be prevented from intruding into a space between the weather strip and the flange. In addition, a force needed to attach the weather strip to the flange can be reduced to facilitate the attachment of the weather strip, and the sealant member can be stably held in the base portion.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A weather strip for a motor vehicle, which is capable of providing a seal between an opening portion of a vehicle body, and a closing member for closing the opening portion, comprising:
a base portion in which a flange provided in one of the opening portion of the vehicle body and the closing member is adapted to be inserted, said base portion including at least an outer side wall and a bottom wall;
a seal portion integrally formed with said base portion for contacting one of the opening portion and the closing member, and sealing between the opening portion and the closing member; and
a sealant member composed of a highly foamed sponge material with a specific gravity of not more than 0.2 and formed separately from said weather strip, and held with said bottom wall, whereby a projecting end of said flange is inserted into said sealant member.

2. A weather strip for a motor vehicle, which is capable of providing a seal between an opening portion of a vehicle body, and a closing member for closing the opening portion, comprising:
a base portion in which a flange provided in one of the opening portion of the vehicle body and the closing member is adapted to be inserted, said base portion having one of a generally U-shaped cross-section and a generally J-shaped cross-section and including an outer side wall, an inner side wall and a bottom wall;
a seal portion integrally formed with said base portion for contacting one of the opening portion and the closing member, and sealing between the opening portion and the closing member; and
a sealant member composed of a highly foamed sponge material with a specific gravity of not more than 0.2 and formed separately from said weather strip, inserted in a bottom of an interior of said base portion, and bonded to said bottom wall.

3. A weather strip for a motor vehicle as claimed in claim, wherein said sealant member is composed of one of an EPDM rubber and a thermoplastic olefin elastomer, and bonded to an interior of said base portion with an adhesive film composed of a thermoplastic olefin resin with thermal welding such that when said base portion is attached to said flange, a projecting end of said flange is inserted into said sealant member.

4. A weather strip for a motor vehicle, which is capable of providing a seal between an opening portion of a vehicle body, and a closing member for closing the opening portion, comprising:
a base portion in which a flange provided in one of the opening portion of the vehicle body and the closing member is adapted to be inserted, said base portion including at least an outer side wall and a bottom wall, and having at least a generally L-shaped cross-section, a double-sided adhesive tape being bonded to an interior surface of said outer side wall, said outer side wall being bonded to an exterior side face of said flange with said double-sided adhesive tape;
a seal portion integrally formed with said base portion for contacting one of the opening portion and the closing member, and sealing between the opening portion and the closing member; and
a sealant member composed of a highly foamed sponge material with a specific gravity of not more than 0.2 and formed separately from said weather strip, and bonded to said bottom wall, whereby a projecting end of said flange is inserted into said sealant member.

5. A weather strip as claimed in claim 4, further comprising a sealant holding lip which extends from said bottom wall obliquely toward said outer side wall to have a generally J-shaped cross-section.

6. A weather strip as claimed in claim 5, wherein said sealant holding lip has such a height that when the flange is inserted in an interior of said base portion, the flange slides on a projecting end of said sealant holding lip and is inserted into said sealant member.

7. A weather strip as claimed in claim 5, wherein said base portion further includes a sealant holding projection which projects from an interior surface of said outer side wall near said bottom wall for holding said sealant member with said sealant holding lip and said bottom wall.

8. A weather strip as claimed in claim 1, wherein the closing member is a vehicle door, and said weather strip is a door opening trim weather strip.

9. A weather strip as claimed in claim 1, wherein an insert member is embedded in said base portion so as to be separable in said base portion into a plurality of insert pieces.

10. A weather strip as claimed in claim 1, wherein an insert member is embedded in said base portion so as to be contractible and stretchable in said base portion.

11. A weather strip as claimed in claim 1, wherein said base portion is composed of one of a solid material and a slightly foamed material, whereas said seal portion is composed of a sponge material and formed to have a tubular configuration.

12. A weather strip as claimed in claim 1, wherein said seal portion is composed of a sponge material of one of an EPDM rubber and a thermoplastic olefin elastomer, and said base portion is composed of one of a solid material and a slightly foamed material of one of an EPDM rubber and a thermoplastic olefin elastomer.
